(19) United States
(12) Patent Application Publication
(10) Pub. No.: US 2022/0050249 A1
(43) Pub. Date: Feb. 17, 2022

(54) Two-part and terminal connectors with conductor management device for use in hazardous environments

(71) Applicant: Aegir Technologies Limited, Horning (GB)

(72) Inventor: David Hilbeck, Horning (GB)

(73) Assignee: Aegir Technologies Limited, Horning (GB)

(21) Appl. No.: 17/433,878

(22) PCT Filed: Feb. 26, 2020
(86) PCT No.: PCT/IB2020/051638

§ 371 Date: Aug. 25, 2021

(30) Foreign Application Priority Data
Feb. 26, 2019 (GB) 1902561.8

(51) Int. Cl. G02B 6/38; H01R 9/24; H01R 13/533; H01R 13/523; H01R 13/52; G02B 6/44

(52) U.S. Cl. CPC G02B 6/3817; H01R 9/2416; H01R 13/533; G02B 6/3887; H01R 13/521; G02B 6/4427; G02B 6/4472; H01R 13/523

(57) ABSTRACT

A terminal connector or two-part connector comprising male and female parts having respective contact pins and contact receivers (10,15) of a construction generally known in the art. In the body (1) of the or at least one part, closely juxtaposed a terminal block (9), there is provided a conductor management device (8) adapted to receive conductors (12) as they are unbundled from the connected cable or reel and support the unbundled or individual conductors through the transitional region of the connector part to where they are secured at the terminal block (9). The conductor management device (8) has through body apertures defining each conductor path (14) to align each conductor with its respective receiver (13). In a different configuration, the conductor management device provides strain relief to the conductors, provides support and conductor rigidity, provides a locking means and is a bore modifier.

### FIELD OF THE INVENTION

The present invention relates to two-part and terminal connectors specifically constructed for use in hazardous environments, particularly multiple conductor connectors but including single channel connectors.

The invention is more particularly directed to the provision of two-part, multi-conductor, connectors for use in extreme environments, most notably subsea environments, and includes terminal connectors, such as those adapted for coupling to fixed installations and remotely operated vehicles (ROV's). The invention is most particularly directed to the provision of two-part, multi-conductor, wet and dry mateable subsea electrical connectors for use in hyperbaric environments, which typically continuously operate at low voltages and low amperages.

The invention is further directed to multi-conductor connectors for data transmission and sensor feed receipt and includes applications where waveguides such as optical fibres are either the preferred conduits or are combined in hybrid connectors.

It will be understood that certain terms used in the description which follows are intended to describe specific situations and should not be interpreted as limiting of the scope of the invention or its use. The term “conductor” is, in its ordinary meaning, directed to single core or multi stranded wires covered by an insulating sleeve and one of usually a plurality of individual wires within a multiple conductor cable. Such cables can be constructed and rated for power applications, including for example, electrical feeds to remote equipment, and for data transmission, for example, signals or video camera feeds. Although the invention is primarily directed towards electrical connectors, single and multiple channel waveguide connectors, most commonly in the optical and near optical range, are often used in hyperbaric and extreme environments and these connectors and the fibres or waveguides therein are known to suffer the same problems in such environments. Accordingly, in the description that follows, the term “conductor” includes any comparable conduit through which power or data may be transferred. Reference is also made hereinafter to “unbundling” a conductor from a cable and this generally is directed to the separation of individual conductors from, for example, an armoured cable within which a number of conductors are constrained. In many circumstances, individual conductors are brought together at a connector as a loom and formed into a cable by wrapping or sheathing the aggregated conductors within a mechanically protective and insulating outer casing which may include multiple layers. It will be appreciated by the skilled addressee that conductors may be “unbundled” from a reel where no stripping back of a protective outer sheath is necessary or from a cable formed from an aggregate of individual conductors bundled together. Where the context relates to one interpretation, equal weight ought to be given to the other.

The term “hybrid connector” is often used interchangeably to denote the use of both wire and fibre channels within a connector but also to indicate use for both power and data connectivity (irrespective of whether data is carried by wire or fibre).

Although the invention is directed to low voltages and low power applications, no such limitation should be taken or inferred. Disadvantages addressed herein apply equally to high power rated terminations.

A particular concern of the present invention is cable termination where the conductors of the cable are unbundled and exposed for connection to each connector terminal (or contact interface). In the transitional region after unbundling, the sheathed conductors do not normally have any support and a phenomenon referred to as “birdcaging” where the conductors buckle (and occasionally twist) creates known operational problems. The physical position of the conductors is maintained after immersion in a potting compound, often an epoxy, however, there is no control of the position of the conductors and consequently the amount of support or strain relief provided by the potting compound is unquantifiable and prone to vary during the operational life of the termination. This phenomenon is more critical with optical fibres which are particularly prone to damage and where fibre bend radius is a factor. The choice of potting compound often relates to its application within the connector where soft flexible elastomeric compounds are poured or injected into the cavities within the connector at the interface of the terminal contacts where the conductors are secured at a terminal block and in the transitional region where the conductors are unbundles from the cable. Harder, inflexible resinous compounds tend to find their uses in the regions where the cable enters the connector housing prior to unbundling.

The term “hazardous environment” as used hereinafter is intended to refer to any environment where components or materials may be vulnerable to failure due to ambient conditions. Examples of such include: corrosion, due to seawater, drilling fluids, electrolytic decomposition or bombardment by atomic oxygen (common in orbital and deep space environments); high and low temperatures and cycling between; high and low pressure and cycling between; and where subject to physical stresses.

In the exemplifying embodiments of the prior art and in the description below, it is common to illustrate in-line connectors as unmated male and female parts making up the connector. As is well appreciated, many applications relate to connections where one part (often the male part, as it has exposed terminals) is provided on a cable end and the corresponding (normally female) part is attached to or integrally formed with the body of a tool, piece of apparatus, remote vehicle or installation.

Where one part is fixed the connector is often referred to as a “terminal connector” or “bulkhead connector”. Accordingly, in the description provided hereinbelow, a reference to two-part connectors includes single parts of a connector and all comparable cable termination arrangements.

### BACKGROUND TO THE INVENTION

The offshore oil and gas industry is well developed and has well-appreciated requirements with regards to the characteristics and operational environments within which people, machinery and equipment must operate. Subsea electrical systems have been developed to handle a variety of tasks at extreme pressures and within corrosive environments on the sea-floor at depths of up to several thousand metres and to provide electrical and communications feeds to allow remote operations. Electrical and data or hybrid connectors all find uses in multiple specialised fields whether that be for well completions, oil and gas separation, flowline connections, various maintenance tasks requiring diver or manipulator assistance and so forth, however, for ease of reference, subsea applications will be the primary focus in the description that follows. To provide the electrical power necessary to remotely operate the subsea systems, reliable electrical cables and connectors, operable at high voltages and currents, are required. Other examples of subsea machinery having high electrical power requirements are underwater construction and mining equipment, subsea work vehicles and power transmission lines.

In more recent years, the ongoing development of operations in extreme conditions has included off-shore wind and tidal energy generation, the transmission of power to and from off-shore and deep-sea installations, underwater mining and sea-bed scavenging for mineral deposits and has extended to space exploration and the proposed construction of orbital, lunar and, in due course, installations and systems for harvesting of resources from asteroids and planetary bodies. One of the critical aspects of each of these areas is the provision of electrical and communications links with remotely operated and autonomous vehicles and probes.

In many applications, extremes of temperature are experienced, for example, down-well applications and applications where drilling fluids are present, high temperatures (circa 200 C) are common and cycling between −20 C and 200 C is known. Extreme low temperatures of −200 C and high temperatures (in excess of 200 C) can be experienced by orbital systems.

A particular concern of the invention is electrical pin-and-socket type connectors that are intended to be mated in a dry or wet environment and then deployed in a conductive, corrosive or high-pressure environment, most notably at depth in seawater. Connectors of this type generally have receptacle connectors with male contact pins and plug connectors with female contact sockets that are sealed from the exterior environment after mating in such way that when they are engaged together an insulated and isolated electrical connection is made. There are three main categories of this type of connector: the first being those that accomplish environmental sealing by having the connector male contact pin enter the female contact bore and simultaneously seal the bore and make the electrical connection with the female contact socket and are generally referred to as “interference fit”; the second being those connectors that accomplish environmental sealing by having an elastomeric compression seal on the plug connector that is energized when it is mated to the receptacle connector and are generally referred to as “compression fit”; and the third where 0-ring or similar type seals are used to provide the environmental seal between the two mated connector halves (and between the outside and inside of the connectors).

In much of the prior art relating to subsea electrical and data connections, the subject of whether a connector is designed to be first engaged outside of the hazardous environment (and generally referred to as “dry” or “dry mateable” connectors) or within (generally referred to a “wet ” or “wet mateable” connectors) is considered critical. For most practical purposes and in respect of the most relevant prior art, the preponderance of the prior art related to connectors that can be repeatedly connected and disconnected within their respective hazardous environments as it is highly impractical to remove the connector or system to which it is attached into a non-hazardous environment for the purpose of mating the two connector halves together.

Most wet mateable connectors must be capable of operating in extreme environments and deal with significant hydrostatic and often fluctuating pressures and the corrosive nature of sea-water or, where applicable, drilling fluids. Connectors which have dielectric fluid within one or each part of the connector, and capable of equalising the pressure differentials between the (outside the connector) and the internal environment (within the connector) when mated or unmated, eliminate many of the problems associated with hyperbaric pressures. Most, however, do not adequately address the problems associated with axial tension stresses on the cable connector conductors or compressive or shear stresses on terminal connector conductors.

Interference fit connectors can be mated dry or wet and typically comprise male and female elastomer portions that when mated together provide a squeezed interference fit between the male and female parts, thereby generating an environmental seal between the outside and inside of the connector contact parts. Interference fit connectors are typically used for short term applications especially where they can be readily replaced.

Known performance and reliability issues that exist with interference fit connectors include the inability to support compression forces that are generated during service by cyclic and high differential hyperbaric pressures, in the unmated, ‘open face’ condition. The general construction of this type of connector can also include unsupported electrical contacts, uncontrolled conductor management and uncontrolled potting at the rear of the bulkhead connector. These uncontrolled elements can lead to poor product quality and in-service performance and reliability issues.

Compression seal connectors should ideally be mated in a dry environment and typically comprise a plug connector with female contact sockets that are located within a moulded elastomeric body. The elastomeric body is bonded to the plug connector body in such a way that a face compression seal is created. When the plug and receptacle connectors are fully mated together, the face compression seal is energized against the front face of the receptacle connector, thereby generating an environmental seal between the outside and inside of the connector. Compression seal connectors are typically not suitable for long term use or applications where high reliability is required.

Known performance and reliability issues that exist with compression seal connectors include the lack of robustness of the elastomeric compression seal, the inability to support compression and resultant shear forces that are generated during service by cyclic and high differential hyperbaric pressures, in the ‘reverse pressure’ condition. The general construction of this type of connector can also include unsupported electrical contacts, uncontrolled conductor management and uncontrolled potting at the rear of the bulkhead connector. These uncontrolled elements can lead to poor product quality and in-service performance and reliability issues.

A typical mated connector assembly consists of a pressure supporting bulkhead connector and a mating cable connector. The cable connector male pin contact or female socket contact being terminated to the cable conductor, the cable jacket over-moulded to the cable connector body and the pressure supporting bulkhead connector male pin contact or female socket contact being terminated to the inboard pigtail hook-up wire conductor.

In U.S. Pat. No. 4,142,770 to Butler (Exxon) a two-part underwater wet-mateable connector is disclosed, in which the cable comprises multiple insulated conductors, as they split off from the cable, enter a cable termination chamber where they are redirected towards outlet ports thereof from which they enter respective conductor terminal cylinders. The cable termination chamber is filled with a neoprene or polyurethane potting compound. The guiding or protecting of the conductor is not continuous across the transitional region. A metal collar 17 to provide strain relief to the cable and individual conductor holes 29 are presented which may be perceived to guide the unbundled conductors towards their respective terminals. This technically could prevent “birdcaging” although it is not discussed. It is noted at Column 4, lines 15-20 that “Insulated conductors 24, as they split off from cable 13, enter cable termination chamber 28 which is filled with an encapsulation compound. Ports 29 located at the base of chamber 28 direct the conductors into their respective conductor termination cylinders 31.” Accordingly, there is no guiding or alignment of the conductors and support is provided only by the potting compound after encapsulation.

US Patent Application Publication No. US 2013/0312996 to Nicholson (Schlumberger) shows cable tubing having a plurality of cables supported therein by a main supporting spine and a number of interlocking segments to define a protective casing. Although the subject matter of the disclosure relates to the provision of a subsea cable connection, the support spine and protective segments do not provide a transitional regional guide or offer protection within a connector part.

U.S. Pat. No. 4,441,777 to Harootion (Whittacre) relates to a hermetically sealed connector and cable assembly having a heat resistant housing with a central passageway for operably connecting thermocouples in a very specific, extreme temperature environment. Although the disclosure is directed to a terminal connector for thermocouples, it allows for other uses, where unbundled conductors 18, 20 which are passed through a disc-shaped dielectric element 28 having apertures 30, 32 which provide keying for the disc element and pins 40, 42, however, the design does not lend itself to multiple conductor connectors used in variable pressure environments such as those experienced by wet and dry mateable subsea connectors.

US Patent Application Publication No. US 2007/0155237 to Cairns et al (Ocean Design) describes mateable connector portions each having a base 18a, 18b (terminal blocks) for holding the respective male and female contacts 20a, 20b which extend rearwardly though respective dielectric nipples 30a, 30b. Each connector portion 12a, 12b includes an elastomeric inner seal 14a, 14b and an outer seal 16a, 16b surrounding the inner seal. Each inner seal 14a, 14b has passageways 24a, 24b which stretch to accommodate the contacts 20a, 20b and are positioned adjacent its respective base 18a, 18b. The inner seals 14a, 14b also have nipple passageways 29a, in communication with the cable passageways 24a, and may include intermediate diameter passageways 27a to accommodate the contacts 20a, the objective being to eliminate adhesive (and presumably also potting compound). As will be appreciated by the skilled addressee, the inner seal 14a, 14b is effectively a boot stretched over the conductors and nipples to cover them once the conductors have been secured to their corresponding contacts in the terminal block 18a, 18b and thus provide no guiding or alignment of said conductors or additional support beyond that which might be expected were a potting compound used instead.

U.S. Pat. No. 4,266,844 to Chelminski (Bolt Associates) relates to a high strength submersible electric cable and connector assembly of the type subject to extreme pressures and stresses in use. The document describes cable connectors 46 seated within a non-conductive anchor plug 40 which is then encapsulated by an insulating material which fills the sleeve body in which the anchor plug and electrical connections are disposed. From the description it can be seen that the terminal block 26 securing the terminal connections 28 is separate from the anchor plug 40 and smaller gauge hook-up wires 50 link the connectors 46 to the terminal contacts 28. The deleterious ‘birdcaging’ effect noted above is illustrated as part of the preferred construction of FIG. 1.

The conductors 32 are manually crimped in sleeve elements 46 positioned in sockets 47 (FIGS. 3 & 4) in the non-conductive anchor plug which is described as a strain-relief member. Each sleeve element 46 has a hook up wire: “these electrical connectors 50 are soldered into the cable ends of respective sockets 28 and are supported by insulating shrink tubing 52.” A stated object of the present invention is to eliminate uncontrolled conductor management in the transitional region between where conductors are unbundled from the cable and the contact interface (usually on the inner face plate of the terminal block). It is also a sought objective to eliminate potting from the same region. The solution proposed by Chelminski is to have an interim interface and to move potting and uncontrolled conductor management to the region between the contact interface and the terminal block. Furthermore, when the potting compound is injected into the cavity 55 in which the hook-up wires 50 are disposed, it is forced past the anchor plug 40 along the flutings 38 provided around its periphery to allow the cavity 55′ in the unbundling region and the flared ends 48 of the conductor passageways 44 to be filled. Insulating heat-shrink tubing may add an element of rigidity to the hook-up wires 50 but are not supporting or guiding and additional internal connections increase the incidence of connector failure. These are all considered retrograde steps. International Patent Application Publication No. WO 02/50958 to Nicholson (Diamould) discloses an electrical connector and method of making an electrical connection for high electrical integrity in arduous conditions where fluctuating mechanical forces may be translated from the cable to the conductor. There is provided at the transitional region of the conductors a flexible boot 23 having collars through which the insulated conductors 9 pass as they are unbundled from the cable core 6. The boot of further defines chambers 28 which are filled with a mechanically soft, essentially incompressible gel (potting compound) to provide electrical insulation and mechanical support to the conductors adjacent to the connector terminals in the conventional manner. The document teaches that the conductors are bent to fit the insulating boot assembly and that tools and templates are required for this purpose. Thus, the flexible boot 23 conforms to the conductor path and provides no guidance or alignment of the conductors with respect to the terminal contacts.

Preceding the above Nicholson (Diamould) disclosure, United Kingdom Patent Application Publication No. GB 2 338 119 to Nicholson (Tronic) discloses a pothead for connecting an electrical cable to a connector part, which includes a diaphragm enclosure forming a chamber for containing a dielectric gel. The enclosure sealingly engages the connector at one end and has an angled cable boot at the other which directs the insulated conductor towards the connector terminals.

US Patent Application Publication No. US 2011/0189878 to Rogers (Tronic) discloses a multi-conductor connector having a conductor support structure adapted to suppress conductive cross-talk between terminal conductors. Similarly, European Patent Application Publication No. EP 3 322 045 to Haring (Engeser GmbH), U.S. Pat. No. 9,515,415 to Lyon (Tyco), U.S. Pat. No. 4,047,797 to Arnold (ITT) and US Patent Application Publication No. US 2009/0264021 to Feldner (Phoenix) illustrate support and guiding devices for conductors after splitting from a cable. None of these documents describes use in a hazardous environment.

Exemplary of the above, U.S. Pat. No. 4,047,797 to Arnold (ITT) discloses a fibre optic connector comprising a support member or yoke 12 which may include a ‘spider’ 104 having grooves 106 to accommodate unbundled fibres and to facilitate the termination of the fibres at fibre optic contacts 48 and to mount terminated fibres in the connector without overstressing the fibres.

It should be noted that the sole relief for axial stress is relayed via the reinforcement 38 in the cable 14 via the restraint member 34 through the connector support member and into the coupling nut 18. Accordingly, no consideration is given to axial stresses of the individual fibres as no gripping, guiding or support is provided in this direction by the open slots 106 of the spider 104. The only stresses considered on the fibres are those when the fibres are cut to provide flat surfaces to termination within the ferrules 20 and those involving angular deflection when unbundling, mating or unmating.

It will also be seen that no protection is provided by the yoke until after the connector is closed, as explained at Column 5 line 9: “Thus, when the caps are mounted on the forward section of the yolk and the yoke assembly is inserted into the shell 16, a radially compressive force is applied to the elastomeric spider 104 causing the slots to partially close, thereby resiliently gripping the fibres 40 to protect the fibres against high forces due to rough handling of the connector and against vibrations.” This arrangement appears counter-intuitive as no lateral protection can be given to the fibres until the slots 106 are closed but the connector can't be closed until after the individual fibres have been cut and polishing has been completed so that the fibres can be terminated in the ferrules 20.

Also exemplary of the above is US Patent Application Publication No. US 2009/0264021 to Feldner (Phoenix) which describes a terminal connector which includes a plug disposed within the connector housing and having a locking mechanism for translating axial stresses to a mounted signal connector. The plug (or insertion member 22) acts in the transitional region but does not abut the face plate of the terminal block in use. As illustrated in FIG. 6, the plug (also referred to as a deflection device 13) incorporates a spreading device 14 which acts to separate the conductors (more correctly, waveguides) 3, 4 but does not guide, support or align them in any real sense. Visually, the plug appears very similar to traditional audio DIN plug inserts. The disclosure specifically mentions allowing for kinking of the conductors (effectively the equivalent of ‘birdcaging’) and refers to this as a means which “ensures well-defined bending of signal conductors.”

Solutions applied have covered all types of connectors including multi-conductor, wet and dry mateable connectors and termination connectors, however, there is an obvious paucity of publications addressing or appreciating the problems associated with guides, supports or protecting means for the conducting wires of the cable in the region where the cable core is unbundled and individual wires are aligned with prospective conductor terminals or terminal contact interfaces in the connector part.

Relatively recent improvements in manufacturing techniques such as additive manufacturing (3D printing) now enables more complex internal geometry to be created and use of this technology to manufacture the new conductor management devices (CMD's, as discussed hereinafter) enabling more intricate internal wire path guides and in higher numbers (increased density). Electrical conductors and optical fibres can now be managed in a controlled and repeatable way.

As will be readily appreciated from the patent literature, there are many different approaches taken to solving some of the known technical disadvantages. Each area presents specific concerns, however, many aspects are common and will be addressed hereinafter.

It is an object of the present invention to seek to obviate the primary disadvantages associated with prior art constructions of multi-conductor connectors.

It is a further object of the present invention to provide a conductor management device for a connector or connector part for controlling the routing and repeatable placement of each conductor within a connector.

It is a yet further object of the present invention to provide a support means for conductors within the transitional region of a connector where the conductors are unbundled from a connected cable. Specifically, it is an object of the present invention to seek to eliminate uncontrolled conductor management in the transitional region between where conductors are unbundled from the cable and the contact interface (usually on the face plate of the terminal block). It is also an objective of the invention substantially to eliminate potting from the same region.

The invention yet further seeks to provide a bore modifying device for multiple conductor cables so as to controllably present multiple conductor ends at a connection interface or terminal connector array.

The invention additionally provides a conductor locking means for multiple conductor connectors whereby the locking means acts to prevent tension being translated to or through the or each conductor to a connector, connector array or interface which may be prone to damage.

It is also an object of the present invention to provide a connector that is easily retro-fittable and which is not labour intensive to install.

It is the further object of the present invention to provide a simplified method of fitting a terminal connector or connector part to a cable end, apparatus, tool, vehicle or installation.

It is yet a further object of the invention to increase significantly the reliability of connectors fitted in accordance with the preferred constructions.

It is an additional object of the invention to provide a family of modular products that incorporate features refined from those known in the prior art which, in combination with the improved features of the present invention, describe connectors which in use provide repeatably detachable connectors having a component life which exceeds the anticipated operational life of the cable, tool, component, apparatus, vehicle or installation to which it is attached.

The variants of the product of the invention and the uses to which they are applied are not intended to be taken as limiting, merely illustrative of the typical scenarios within which the product, method and system of the invention is adapted for use.

### SUMMARY OF THE INVENTION

Accordingly, the present invention provides a cable termination having a housing adapted to receive a cable at one end and present a contact terminal block at the other, the termination comprising:
a terminal block having one or more terminal contacts each having a contact interface to which the or each exposed conductor of a connecting cable is operably secured;
the terminal block including a face plate to retain the terminal block within a body of the cable termination; and
support means having a through-body passage for receiving each sheathed conductor after unbundling from a connecting cable,

in which the support means guides and supports each conductor after unbundling and presents the conductor in alignment with its corresponding contact interface in the terminal block and is adapted to abut the face plate to provide enhanced structural integrity to the conductors and contact interfaces.

The abutment of the support means to the face plate of the terminal block (and the keying of the support means therewith) ensures the conductors are guided and supported from the transitional region to the contact interfaces and that each conductor is aligned with the respective terminal contacts via the interfaces (contact pins/receivers or ferrules for optic fibres). The abutment also provides sealing and protection of the conductor/interface connections which is further enhanced when the connector part is sealed. Where fluid insulating media is used, further environmental protection is provided.

One of the advantages of the preferred arrangement is that potting is obviated, however, there remain instances where potting may still be used advantageously, for example, for use in supporting the face plate or either alone or in conjunction with an outer seal element where the cable enters the connector.

The support means (hereinafter also referred to as a conductor management device or “CMD” has a front face from which one or more axially aligned apertures penetrate and a rear face from which a corresponding number of apertures penetrate, the apertures being joined together to form through-body passages within the support means. Advantageously, the rear face apertures are angularly disposed with respect to the central axis of the support means (or connector part in which it is to be installed). This reduced manipulation or stresses on the conductors as they are unbundled in the transitional region. Additionally, the apertures may be offset radially from one another to provide bore modification and/or angularly to provide convoluted conductor passages within the support means (CMD).

Conveniently, each conductor is guided and supported within each angularly aligned aperture and each terminal contact interface (pin) is guided and supported within each axial aperture, each being aligned to their respective ones by the passages therebetween.

Advantageously, the termination is a two-part connector comprising:
a first male part having a plurality of terminal contacts extending beyond the face plate;
a second female part having terminal receivers adapted to align and couple with respective ones of the contacts of the male part;
at least one of said parts having a transitional region within the housing thereof where individual conductors are unbundled from a connecting cable which has sheathing to protect the individual conductors from hazardous environments;
the transitional region comprising the area between a cable gripping means and the contact interfaces of said at least one part,

wherein, as individual conductors are exposed from within the protective sheathing and unbundled from the cable core, the support means receives each individual conductor within corresponding through-body passages to present an exposed conductor end in alignment with its corresponding contact interface.

Preferably, the support means provides controlled conductor management by guiding and supporting each conductor presenting the conductor in alignment with its corresponding contact interface in the terminal block, in which each through-body passage is shaped in such a way so that the in use position of each conductor in relation to the central axis of the support means as presented to the face plate of the terminal block is different.

Conveniently, the housing includes a cavity adapted to receive isolating media and the guiding passages each including sealing surfaces so as to prevent fluid passing from one side of the support means when a pressure differential is present across the support means.

Advantageously, the support means through-body passages define conductor paths therewithin and functionally provides a bore area adjustment means to modify the space provided between each conductor and to align the conductors with respective contact interfaces at a terminal block within the housing of the cable termination or one or both of the male and female parts thereof.

In a first preferred embodiment, the first male part has a plurality of terminal contacts and the second female part has terminal receivers adapted to receive and electrically connect with respective ones of the terminal contacts, each part having a cavity containing fluid electrically insulating media and said female part having means to ensure conductivity between the contact interfaces of the respective parts to define an electrical connector.

In an alternative construction, the two-part connector includes a first male part which has a plurality of contact interfaces or ferrules aligned with exposed optical fibres or waveguides each presenting at terminal contacts and the second female part has terminal receivers adapted to align and couple with respective ones of the terminal contacts and are optically coupled to corresponding fibre interfaces/ferrules, a cavity containing optically isolating media and said female part having biasing means to ensure alignment and interfacing of the prepared terminal contacts and said receivers to define an optical connector.

Preferably, the support means comprises a monolithic block of an electrically insulating pressure resistant plastics material and selected ones of the passages defined therein deflect from the central axis to effect a bore adjustment means. Ideally, the support means is formed using a three-dimensional or additive manufacturing technique so as to define convoluted conductor passages therein.

It will be appreciated that the use of rubber and ‘softer’ more flexible elastomeric seals and housing components used in the prior art (and most likely moulded) do not have the same characteristics as a hard thermoplastics support means defining the conductor management device (CMD) of the invention which provides a mechanically robust, incompressible, pressure resistant body where conductors and contact interfaces to which the conductors are attached cannot be moved from or forced out of their original positions or alignment. Three-dimensional and additive manufacturing techniques allow for internal configurations that are impossible or impractical using traditional forming or moulding techniques.

The support means may comprise two optionally identical monolithic blocks, on disposed in the opposite orientation to the other, so that the deflection of the conductors through said bore area adjustment means provides a locking effect when the blocks abut one another, thereby providing further integrity to the support of the conductors and preventing strain being translated from the cable through the conductors to the terminal block.

Conveniently, the support means may be provided as retrofittable into existing connectors as it does not interfere with the sealing, against the hazardous environment, of the cable termination or of the first or second part of a two-part connector and said terminal contacts or receivers thereof.

In preferred constructions of a terminal connector, the or each connector housing includes an annular retention means bevelled on one side to slidingly receive a radially deflecting ring of a threaded sleeve portion and a locking profile on the other side thereof to retain the ring when axial tension is applied.

Conveniently, the ring of the threaded sleeve portion is slotted to provide regions adapted to radially flare during fitting to a connector housing and subsequently engage the locking profile of said retention means.

Advantageously, a sleeve portion on a first connector part has an external thread and the sleeve portion on the mating connector part has a corresponding internal thread which are interengaged after mating of the connector parts and lock against the locking profiles of the respective retention means.

In a further arrangement, the cable termination connector housing is adapted to sealingly receive a connector insert which cooperates with the connector housing moulding to form an elastomeric terminal block.

The invention provides an underwater electrical connector, wherein the cable termination or either one or both of the male and female connector parts includes a support means of the type defining a conductor management device.

The invention additionally provides an optical cable termination or two-part connector where individual optical fibres are interfaced to ensure passage of data, wherein support means of the type defining a conductor management device is provided.

The present invention further provides a conductor management device comprising a support means of the type herein defined configured as a conductor locking means comprising:
a support means defining first monolithic block having a plurality of conductor routing passages to define respective bore modifying paths within the block; and
a support means defining second block having the same characteristic features as the first but in which the direction of bore modification is opposed,

wherein, in use, the first block is mounted on the presented conductors and positioned at or adjacent a desired locking position before the second block is mounted on said conductors and slid towards the first, so that when the locking position is accurately determined, the first and second blocks are brought into locking engagement.

Conveniently, a sleeve or encapsulating body holds the blocks together effectively to retain the blocks in locking engagement.

Preferably, the two blocks are held within a connector part and subsequently encapsulated by insulating media.

Optionally, the blocks are configured as conductor sealing means whereby the desired locking position comprises an optimum sealing position so that when the blocks abut, they form a sealing engagement.

The invention further provides a method of locking conductors within a cable termination or connector part utilising a support means as herein described, the method including:
unbundling connectors from a multi-conductor cable;
sliding a support means, having a plurality of conductor routing passages defining bore modifying paths within the support means, along the unbundled conductors towards the cable;
exposing the conductor tips by stripping the sheathing therefrom;
fixing the conductors to their respective contact interfaces; and
sliding the device into abutment with the terminal block.

This provides support and alignment of the conductors and prevents “birdcaging” in the transitional region where conductors are unbundled from the cable.

The method further includes sliding a first support means having bore modifying passages onto the conductors to concentrate them radially before sliding a second support means in opposite bore modifying onto the conductors to align the conductors with respective terminal block contact interfaces.

Conveniently a second support means is slid into abutment with the terminal block, the first support means being subsequently slid into locking engagement with the second to prevent strain forces being translated through the conductors to the terminal block.

It will be appreciated by the skilled addressee that in an additional aspect the invention presents a family of modular cable terminations and connectors that incorporate features refined from those known in the prior art which, in combination with the improved features of the present invention, describe connectors which in use provide repeatably detachable connectors having a component life which exceeds the anticipated operational life of the cable, tool, component, apparatus, vehicle or installation to which it is attached.

### BRIEF DESCRIPTION OF THE DRAWINGS

The present invention will now be described more particularly with reference to the accompanying drawings which show, by way of example only, a cable termination in the form of a two-part connector having conductor support means therein, together with details of preferred embodiments of assemblies and components making up an improved termination, and illustrating a method of securing and supporting individual conductors in a transitional region of a cable where multiple conductors of a multicore cable are unbundled. In the drawings:

FIG. 1 is schematic sectional side elevation of a cable termination comprising the male part of a two-part, dry mateable, compression seal connector in accordance with the established prior art;

FIGS. 2a to 2c are schematic sectional side elevations of a male part of a two-part connector of the type shown in FIG. 1 having a conductor support means in accordance with the invention;

FIG. 3 is sectional side elevation of a two-part, dry-mate connector of the invention in an unmated configuration;

FIG. 4 is schematic sectional side elevation of a cable termination comprising the male part of a two-part, wet mateable, interference fit connector in accordance with the established prior art;

FIGS. 5a and 5b are schematic sectional side elevations of a male part of a two-part connector of the type shown in FIG. 3 having a conductor support means in accordance with the invention;

FIG. 6 is sectional side elevation of a male part of a wet-mate connector variant of that illustrated in FIG. 5a having a rotatable externally threaded sleeve;

FIG. 7 is a sectional side elevation of a female part of a two-part connector corresponding to the male part illustrated in FIG. 6 having a corresponding rotatably mounted internally threaded collar;

FIG. 8 is sectional side elevation of a male part of a wet-mate connector variant having an integral externally threaded shell;

FIGS. 9a, 9b 10a and 10b are respectively end views and corresponding sectional side elevations of dry-mate equivalents of the male and female parts of the two-part connector of FIGS. 6 and 7;

FIGS. 11a to 11e is a series of sectional side elevations of a support means according to the invention illustrating the support and bore modifying aspects thereof and the positional locking of the support means when used in conjunction with a second support means;

FIG. 12 is a schematic sectional side elevation of a cable termination having conductor locking strain support and sealing elements in use with a wet-mate connector of the type illustrated in FIG. 5a;

FIG. 13 is a sectional side elevation of a cable termination with locking strain support elements having integral seals to prevent egress of insulating media towards the connecting cable;

FIG. 14 is a sectional side elevation of a pressure balanced cable termination similar to that of FIG. 13 adapted to interface with a pressure balance oil-filled (PBOF) cable system; and

FIG. 15 is a schematic sectional side elevation of a cable termination illustrating the use of a two-part connector comprising male and female parts similar to those shown in FIGS. 6 and 7 combined with an interconnector having locking strain support elements at each end thereof to eliminate axial stresses being transferred to the electrical insert of the female part of the connector.

### DETAILED DESCRIPTION OF THE DRAWINGS

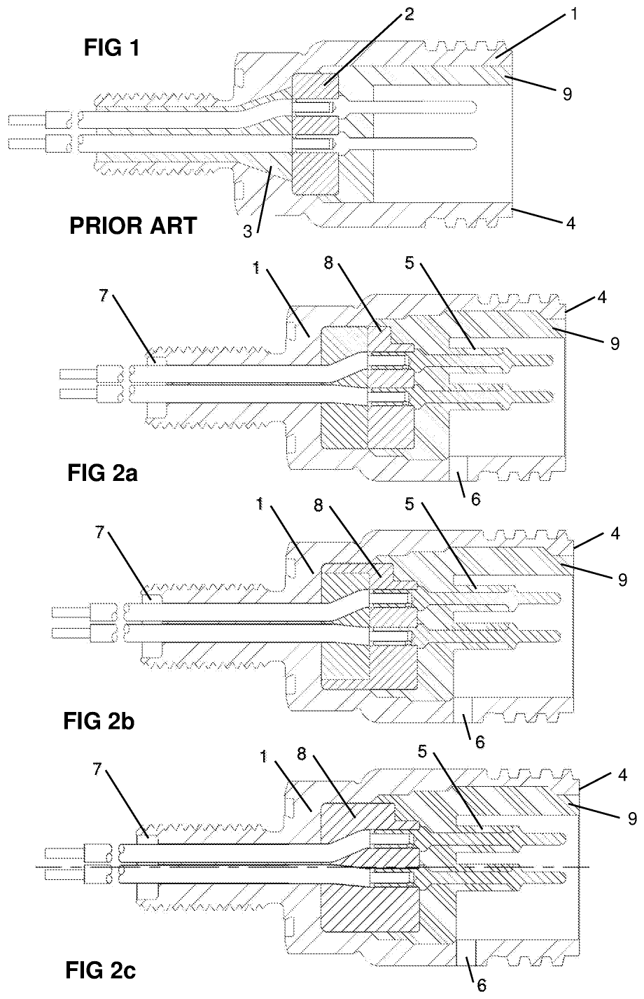

Referring to the drawings and initially to FIG. 1, a two-part dry-mate bulkhead or terminal electrical connector in accordance with the acknowledged prior art has a main body 1 within which there is provided a pressure support plate 2. A potting compound 3 (usually an epoxy resin) cures around sheathed conductors which may, if necessary, have been unbundled from a connecting cable (not shown) and provides support to the conductors and the terminal block within the housing of the conductor part.

In commercially available dry mateable compression seal connectors, having uncontrolled conductor connections, the pressure plate 2 is positioned by a location face within the main body 1. The wires are only fixed in position after the potting compound 3 has fully cured, however, the resultant connectors cannot support high contact count (multiple conductor channels) and tend to fail with repeated connection and disconnection of the two mating parts (only the male part being illustrated here) and when the primary seal face 4 and the compression seal on the front face of the mating connection fail to provide an effective environmental seal.

FIGS. 2a to 2c illustrate improved cable terminations represented here by the male halves of two-part dry or wet mateable connectors in which the potting compound has been obviated by a shaped conductor management device 8 having channels therethrough to accommodate individual conductors, aligning them with corresponding contact interfaces (pins) of the terminal block 9 and supporting each conductor against axial movement during connection and disconnection and radial movement during exposure to hyperbaric pressures. The seal face 4 together with the compression seal on the front face of the mating connector, provide the primary environmental seal. Individual sealing cylinders 5 together with the individual bore seals within the mating connector provide a secondary set of seals that significantly increasing the reliability of the connector. In wet mateable connector applications, the sealing surface 4 is deliberately compromised by the addition of multiple vent holes 6, which provide the escape route for the fluid that is evacuated when the two connector halves are interengaged. Conductor support material 7 is optional and provides no pressure support to the conductors or the terminal block.

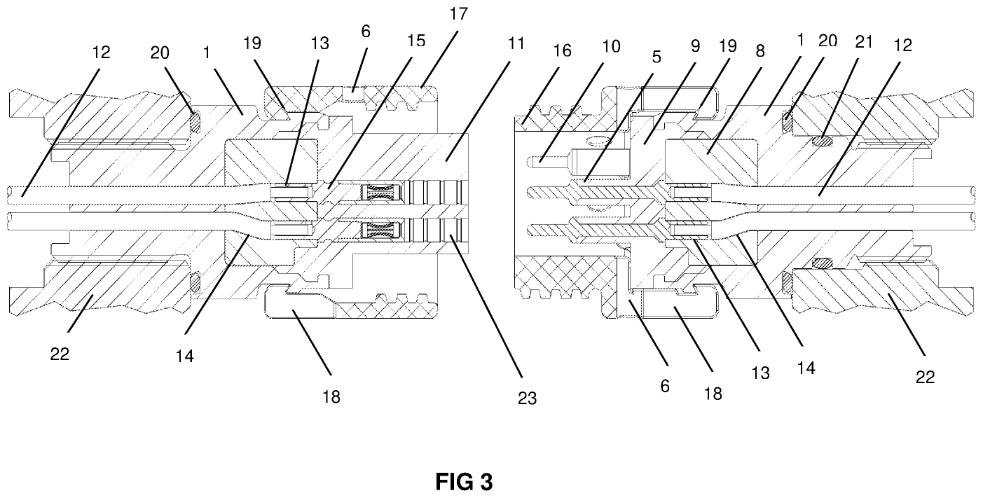

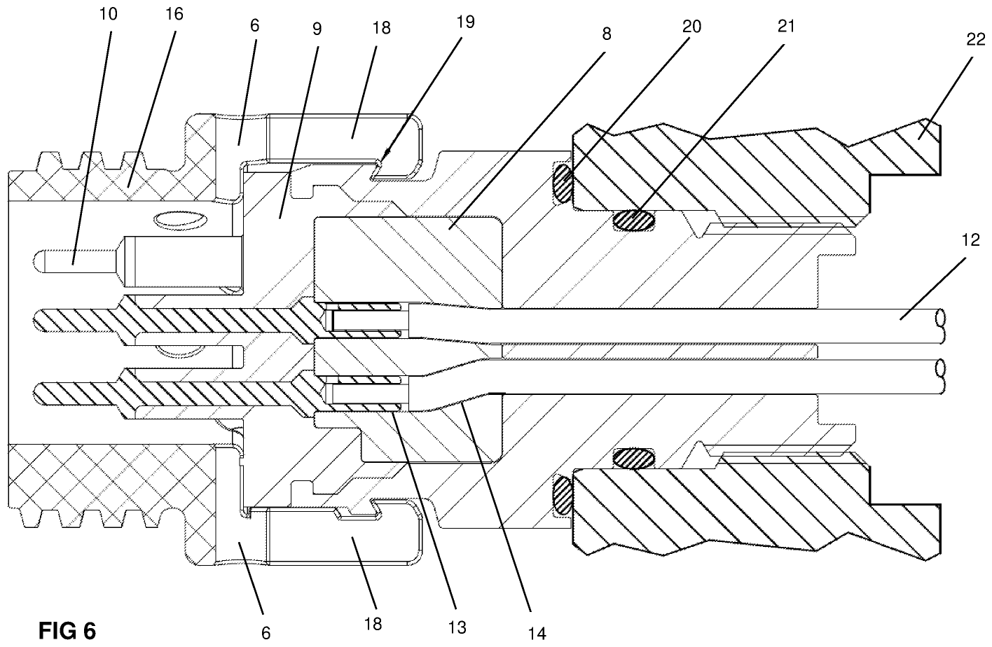

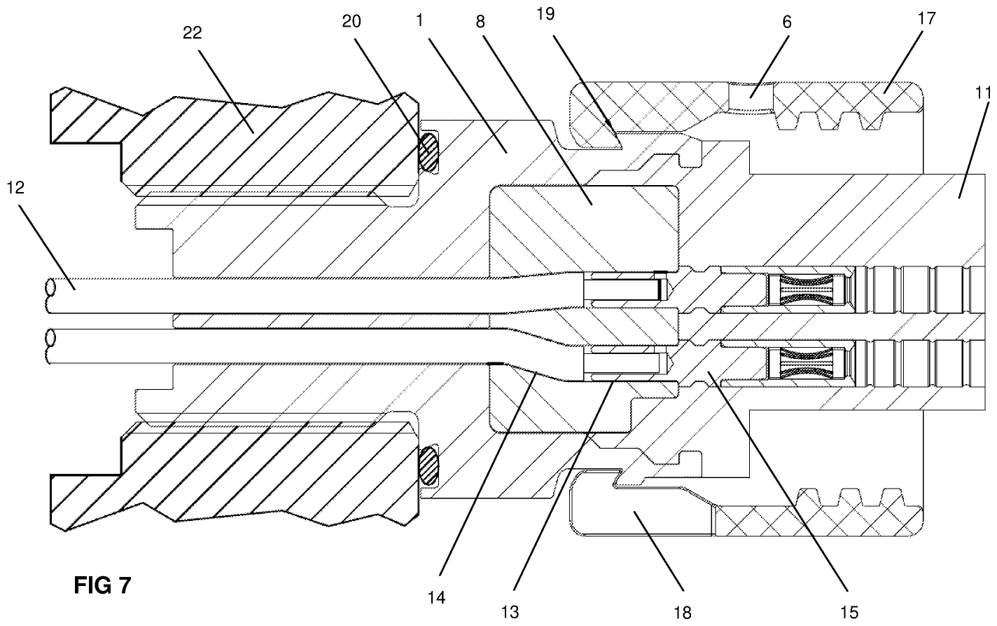

In FIG. 3 (and also with reference to FIGS. 6 and 7) a preferred embodiment of the invention comprises male and female parts each having a main housing body 1 within which a conductor management device 8 is disposed. The terminal block 9 shape defines the male characteristic of the part and includes terminal contacts 10. The shape of the corresponding terminal block 11 defines the female characteristics of the opposite part and includes terminal contact pin receivers 15. Each contact interface (whether pin or pin receiver) is attached electrically onto the exposed ends of individual conductors 12 at an interface point 13.

A conductor management device 8, in its most basic iteration, comprises a monolithic block, within which conductor routing apertures 14 are formed to align respective conductors 12 with their corresponding contact pins 10 or pin receivers 11. In the sectional representation of FIG. 3, only two conductors are shown (for clarity), however, the reader will appreciate that the invention finds particular utility where the number of conductors is greater. Conventionally, four conductors are used for three-phase power applications and sixteen or more conductors for data transfer and sensor feed applications.

Conventionally, the male part has an externally threaded ring 16 attached to the main body 1 and is adapted to be orientated in position with respect to the main body to prevent rotation between the main body 1 and the threaded ring 16. A rotatable internally threaded collar 17 is retained on the main body 1 of the female part and is adapted to receive the annular ring of the male part and draw the two parts together in a sealed and secure configuration. Vents 6 are provided in the threaded ring 16 and the threaded collar 17 to allow trapped fluid, such as sea water, to escape from within the connection area during the interengagement process.

Slots 18 provide flexibility to the sleeve 16 and collar 17 so they can be pushed into place from the front of each respective connector half. An angled retaining means 19 holds the respective slotted ring portions of the threaded sleeve 16 and collar 17 in place and prevents them from being pulled forward and removed from main body 1.

O-rings 20 and 21 provide barrier seals preventing ingress of fluid from the ambient environment into housing 22.

The connector halves are adapted to interengage with each other in such a way that when each contact pin 10 is fully engaged within each contact receiver 15 an electrical connection is established whilst simultaneously sealing each cylinder 5 within each bore 23 thus protecting each electrical circuit from the ambient environment.

Referring now to FIG. 4, a two-part (only the male part is shown) wet mateable electrical connector in accordance with the acknowledged prior art has a main body 1 within which there is provided individual through cavities for conductors 12 to pass through. Conductors 12 are crimped to contact pins 10 and, together with the guide pin 24, the terminal block 25 is moulded to the main body 1 which is fixed by means of a threaded connection to the housing 22. The internal cavity within the housing 22 is sealed from the ambient environment by o-rings 20,21.

Commercially available wet-mate connectors of the type shown in FIG. 4 have uncontrollable, unsupported conductor 12 and contact pin 10 subassemblies within the rubber moulded terminal block 25. This type of connector construction cannot reliably support high differential pressure and tend to fail with repeated pressure cycling.

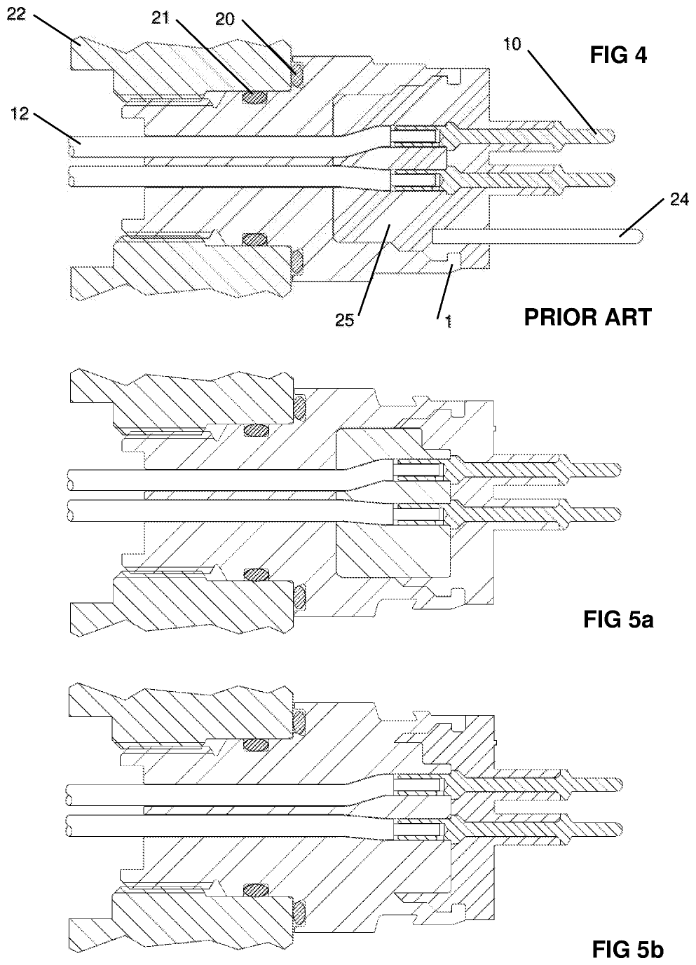

FIG. 5a illustrates improved cable terminations represented here by the male half of a two-part connector in which the potting compound has been obviated by a shaped conductor support having channels therethrough to accommodate individual conductors, aligning them with corresponding contact pins of the conductor management device or terminal block and supporting each conductor against axial movement during connection and disconnection and radial movement during exposure to hyperbaric pressures.

FIG. 5b is similar to FIG. 5a except that the main connector body and the conductor management device are a single piece. This embodiment is of particular benefit when non-metallic or non-magnetic connector bodies are required and/or when low weight is a significant advantage.

A male part of a connector in accordance with the invention in an unmated condition is shown in FIG. 6 and details the use of a conductor management device 8 to align conductors 12 within the main body 1. A terminal block 9 defines the shape of the male characteristic of the part and includes contact pins 10 each of which is attached electrically onto the exposed ends of individual conductors 12 at interface point 13.

A conductor management device 8, in its most basic iteration, comprises a monolithic block, within which conductor routing apertures 14 are formed to align respective conductors 12 with their corresponding contact pins 10

In the sectional representation of FIG. 6, only two conductors are shown in section (for clarity), however, the reader will appreciate that the invention finds particular utility where the number of conductors is greater. Conventionally, four conductors are used for three-phase power applications and sixteen or more conductors for data transfer and sensor feed applications.

Conventionally, the male part has an externally threaded ring 16 attached to the main body 1 and adapted to be orientated in position with respect to the main body to prevent rotation between the main body 1 and the threaded ring 16. Vents 6 are provided in the threaded ring 16 to allow trapped fluid, such as sea water, to escape from within the connection area during the interengagement of the connector halves.

Similarly, a female part of a connector in an unmated condition is illustrated in FIG. 7 and includes a conductor management device 8 disposed within the main body 1. The terminal block 11 shape defines the female characteristic of the part and includes contact pin receivers 15. Each contact pin receiver is attached electrically onto the exposed ends of individual conductors 12 at the contact interface 13.

A conductor management device 8, in its most basic iteration, comprises a monolithic block, within which conductor routing apertures 14 are formed to align respective conductors 12 with their corresponding contact pin receivers 15. In the sectional representation of FIG. 7, only two conductors are shown in section (for clarity), however, the reader will appreciate that the invention finds particular utility where the number of conductors is greater. Conventionally, four conductors are used for three-phase power applications and sixteen or more conductors for data transfer and sensor feed applications.

Conventionally, the female part has a rotatable internally threaded collar 17 fitted to main body 1 of the female part and is adapted to receive the annular ring of the male part and draw the two parts together in a sealed and secure configuration. Vents 6 are provided in the threaded collar 17 to allow trapped fluid, such as sea water, to escape from within the connection area during the interengagement process.

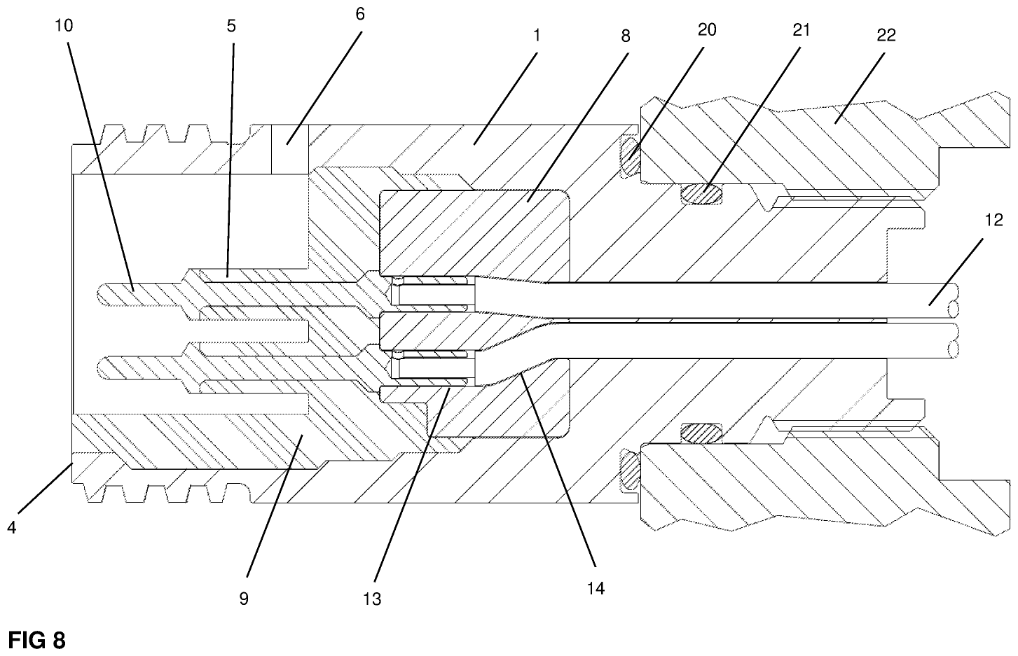

FIG. 8 illustrates the male part of a wet mateable bulkhead receptacle connector with pin contacts in an unmated condition. As before, the conductor management device 8 comprises a monolithic block, within which conductor routing apertures 14 are formed to align respective conductors 12 with their corresponding contact pins 10. The terminal block 9 shape defines the male characteristic of the part and includes contact pins 10. Each contact pin is attached electrically onto the exposed ends of individual conductors 12 at the contact interface 13.

Conventionally, the male part of a wet mateable bulkhead receptacle connector has an external thread. Vents 6 are provided in the main housing body 1, to allow trapped fluid, such as sea water, to escape from within the connection area during the interengagement of the connector halves. A further embodiment is a dry mate version in which the vent holes are not present and where interengagement of the connector halves must be made in a dry environment.

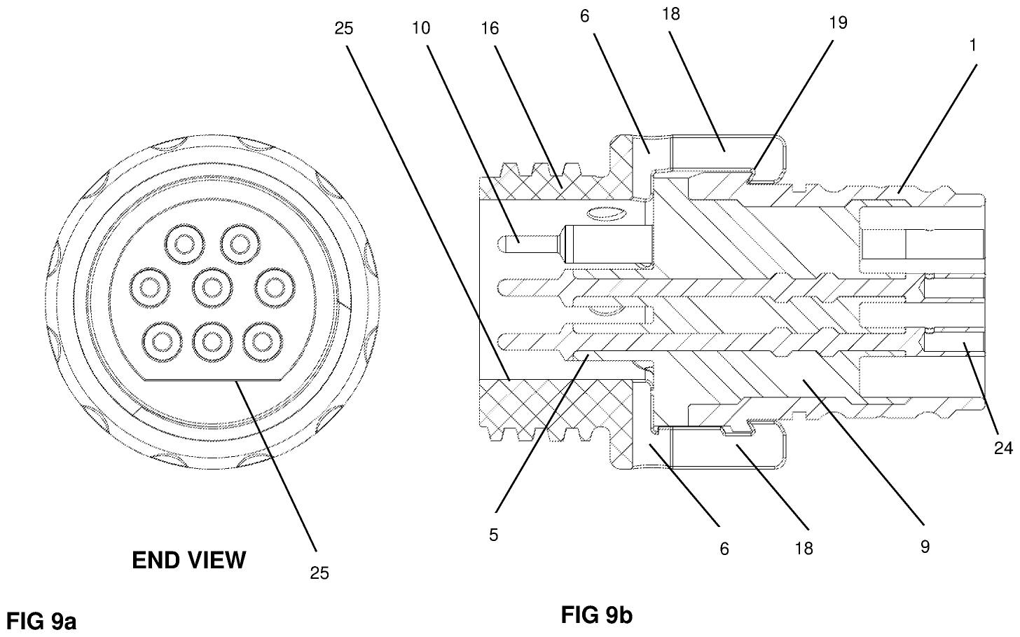

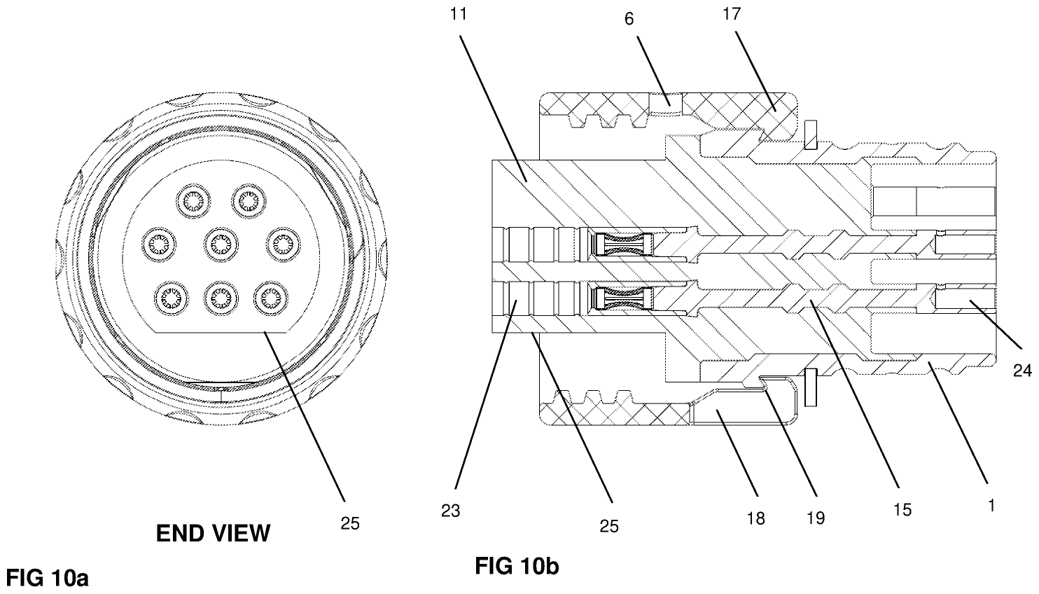

FIGS. 9a and 9b illustrates a cable receptacle connector with contact pins that is interengageable with any connector that has the same number of contact receivers. The terminal block 9 shape, including contact pins 10, defines the male characteristic of the part and is disposed within main body 1. Each contact pin has a solder pot 24 in which to attach an electrical conductor.

The connector halves are adapted to interengage with each other in such a way that when each contact pin 10 is fully engaged within each contact receiver an electrical connection is established whilst simultaneously sealing each cylinder 5 within each corresponding bore thus protecting each electrical circuit from the ambient environment.

Slots 18 provide flexibility to sleeve 16 so it can be pushed into place from the front of main body 1, if desired. An angled sleeve retaining means 19 secures the threaded sleeve 16 in place and prevents it from being pulled forward and removed from main body 1.

As is common in many of the embodiments disclosed a ‘D’ profile 25 provides means of positive alignment with any interengageable connector.

FIGS. 10a and 10b illustrates a cable plug connector with contact receivers that is interengageable with any connector that has the same number of contact pins. The terminal block 11 shape, including contact receivers 15, defines the female characteristic of the part and is disposed within main body 1. Each contact pin receiver has a solder pot 24 in which to attach an electrical conductor.

Conventionally, the female part has an externally threaded collar 17 rotatably fitted to the main body 1. Vents 6 are provided in the threaded collar 17 to allow trapped fluid, such as sea water, to escape from within the connection area during interengagement with a mating connector half. The connector halves are adapted to interengage with each other in such a way that when each contact pin is fully engaged within each contact receiver 15 an electrical connection is established whilst simultaneously sealing each cylinder within each corresponding bore 23 thus protecting each electrical circuit from the ambient environment.

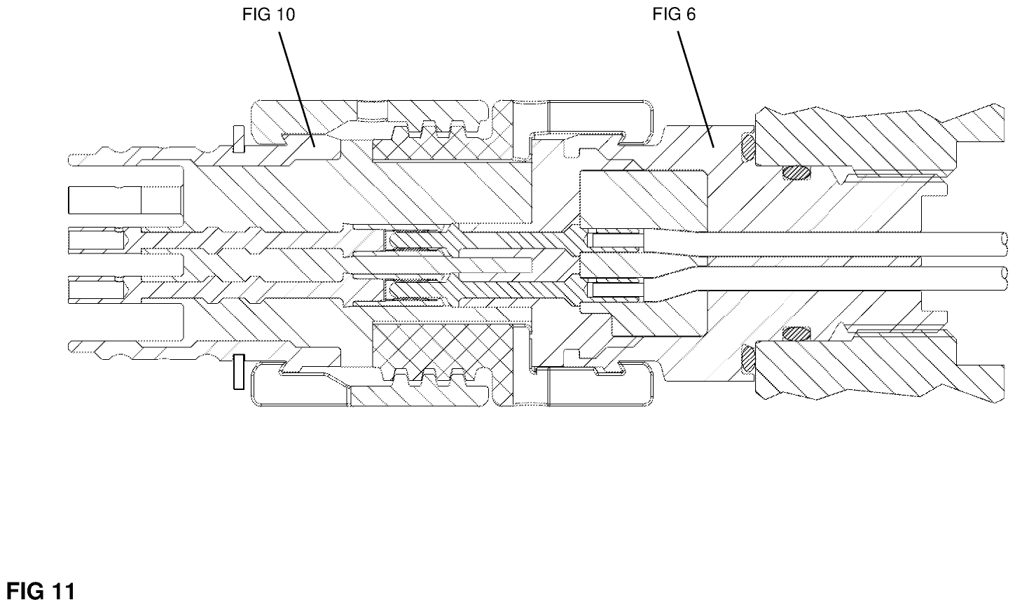

FIG. 11 illustrates a bulkhead receptacle connector with pin contacts, as illustrated in FIG. 6, interengaged with cable plug connector with pin receivers as illustrated in FIG. 10.

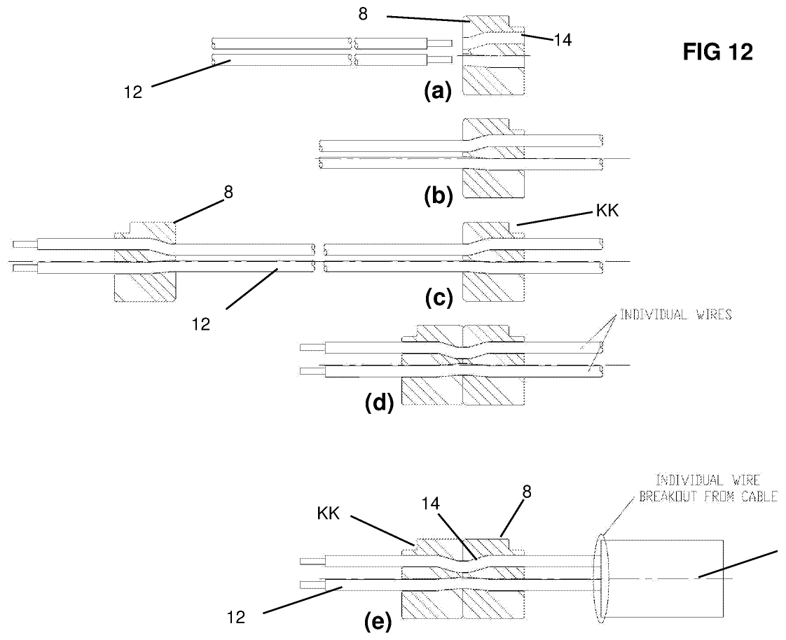

FIGS. 12a to 12e schematically represent the guiding, support, bore modification and locking functions of the conductor management device 8. One or more conductors, unbundled from the cable within which they were retained and optionally having an unsheathed tip for (soldering or) crimping to a terminal, is pushed into one side of the conductor management device 8 and directed along the assigned path of the corresponding conductor routing aperture 14, as shown in FIGS. 12a and 12b. Where the aperture is disposed adjacent the central axis of the device, the conductor is deflected marginally outwardly from said axis as it progresses through the device. Conversely, where the aperture is radially spaced from the axis, the corresponding radial deflection is greater. As will be appreciated from the foregoing, the deflection may be used to more accurately align multiple conductors of a cable with respective terminal sleeves and space the conductors to allow access for (soldering or) crimping at the terminal block. The introduced spacing also defines a bore modification of the collected conductors and this can also be used conversely to concentrate the density of conductors or as part of a stepped process using successive conductor management devices.

As the device 8 is directional, a key KK is used to provide a visual identification of the direction of bore expansion. The key also prevents rotation of the device with respect to the terminal block 9 or connector body 1.

FIGS. 12c and 12d illustrate the use of a second conductor management device 8 which may be slid along the length of the conductors to abut the surface of a first device to form a locked pair to provide strain relief, up to the breaking strength of multiple conductors, or positional locking with a connector body. This arrangement can be used to provide additional conductor support within a connector and to prevent birdcaging of conductors within the transitional region where conductors are unbundled from a cable, as illustrated in FIG. 12e.

In use, a first conductor management device may be slid onto the unbundled free conductor ends of a cable concentrating the bore of the collected conductors for presentation to the second device. The conductors are then pushed through the second device, as described with reference to a FIG. 12a, and the exposed conductor tips (soldered or) crimped to the terminal connectors. The second device is then slid along the conductors to abut the terminal block before the first device is slid along the conductors to abut the outer side of the second device and lock against it. Once the devices are secured within the connector body, this minimises any strain that can be translated through the conductors or cable to the connections on the terminal block.

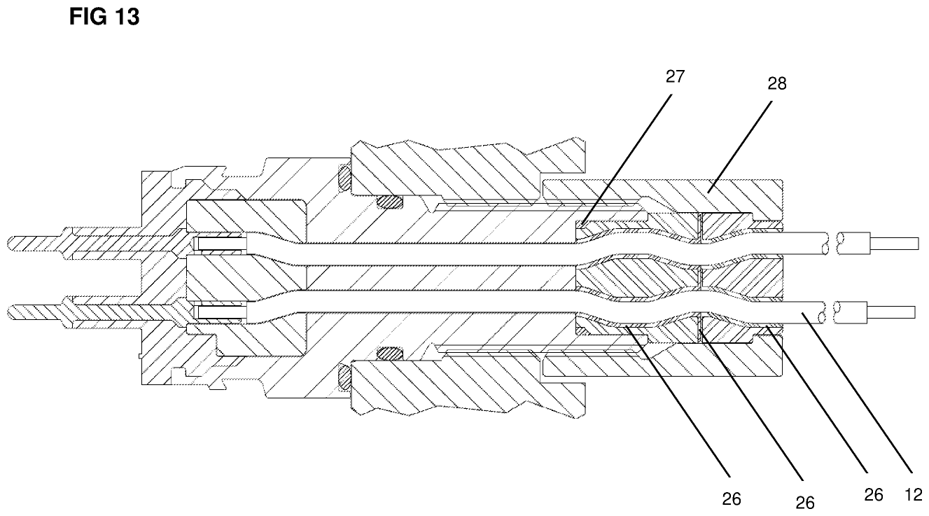

FIG. 13 illustrates a wet-mate connector of the type shown in FIG. 5b but with locking conductor management devices abutting a receiver formed in the housing of the connector. This embodiment of the conductor management device has integral conductor sealing elements 26 within the through-body apertures to facilitate sealing against individual conductors 12 and together with sealing element 27 prevents ingress of fluid from the ambient environment into the rear of the connector. An internally threaded collar 28 locks the conductor management devices 8 securely in place.

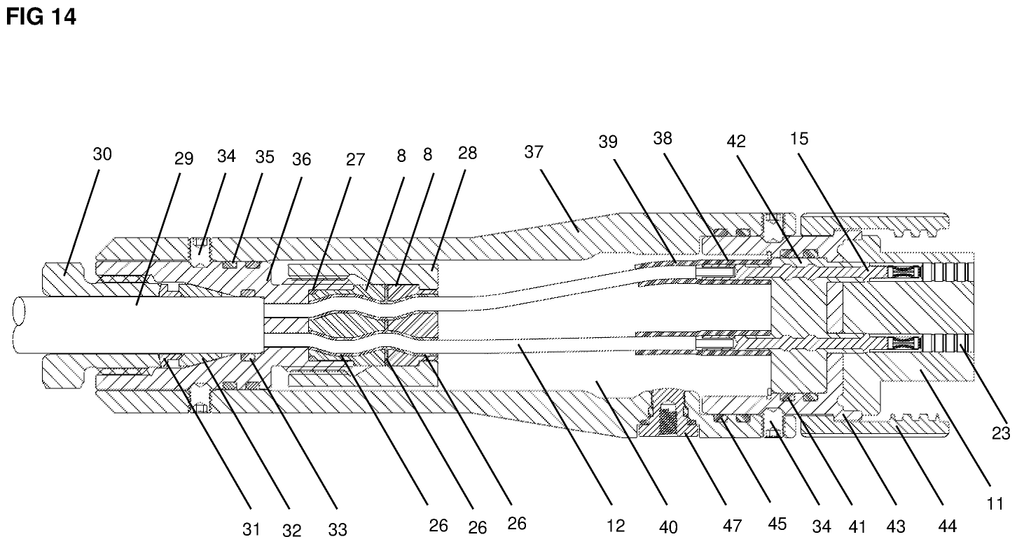

FIG. 14 illustrates a dry or wet mateable cable plug connector with backshell assembly for termination to a cable either in the manufacturing factory or supplied as a kit of parts for assembly in situ at an external site. The assembly is designed so that it can be assembled with standard tools.

A cable 29 is sealably assembled to body 36 by tightening externally threaded ring 30 onto a washer 31 which in turn compresses a cone seal 32 simultaneously onto the cable 29 and housing 36. An o-ring 33 provides a secondary seal between the cable 29 and the housing 36.

The conductor management devices 8 include integral conductor sealing elements 26 within the through-body apertures to facilitate sealing against individual conductors 12 and, together with a sealing element 27, prevents ingress of fluid from the insulating fluid media cavity into the rear of the connector. An internally threaded collar 28 locks the conductor management devices securely in place against the body 36. This assembly supports and retains the individual conductors preventing axial loads from being transmitted further into the assembly and also prevents insulating fluid media from transferring to the external environment.

Conductors 12 assemble electrically to contact pin receivers 15 that are an integral part of insert 42. Boot seals 38 assemble over conductors 12 and insulation posts 39 to provide an electrically insulating barrier between the insulating fluid media cavity 40 and each individual electrical circuit. This is a secondary seal in the event of primary seal failure when conductive media ingresses into the insulating fluid media filled cavity.

An insert 42 is sealed to the connector main body 43 by o-rings 41 to prevent fluid media from fluid filled media cavity 40 coming onto contact with moulded connector terminal block 11. A rotatable threaded ring 44 is fitted over main body 43 and backshell 37 is fitted in place over o-rings 35 and 45 and secured with screws 34. The removal of a fill port screw assembly 47 enables the insulating fluid media cavity 40 to be filled with insulating fluid media. Replacement of the fill port screw assembly reseals the cavity from the ambient environment.

This dry or wet mateable cable plug connector may be interengaged with any receptacle connector with the same number of pin contacts.

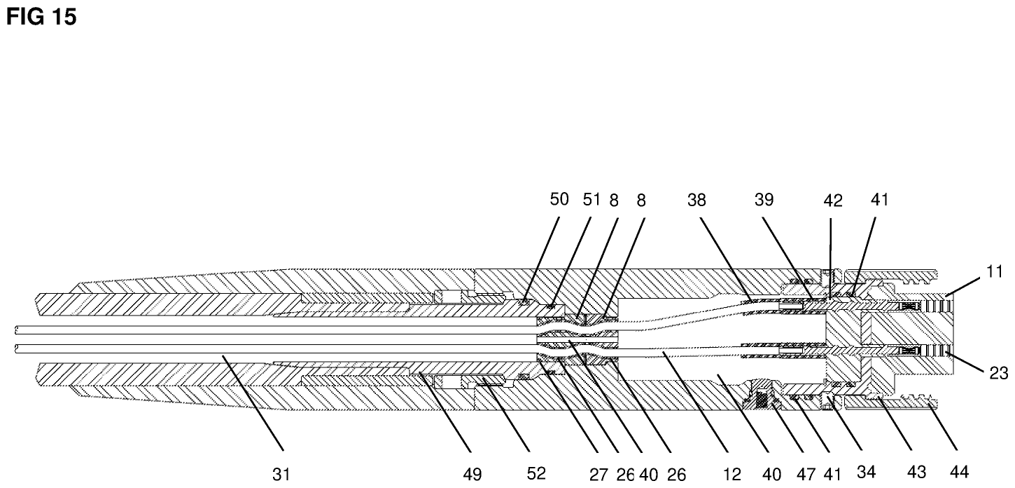

FIG. 15 illustrates a dry or wet mateable cable plug connector with backshell assembly for termination to a pressure balanced oil filled (PBOF) cable. The PBOF cable 49 is sealably assembled to body 37 by tightening an externally threaded ring 52 into housing 37. 0-rings 50,51 seal between the external ambient environment and the connector internals.

As noted, the conductor management devices 8 include integral conductor sealing elements 26 within the through-body apertures to facilitate sealing against individual conductors 12. Through-holes ensure fluid communication between the PBOF cable assembly and the internal fluid filled cavity 40. This assembly supports and retains the individual conductors preventing axial loads from being transmitted further into the assembly.

Conductors 12 assemble electrically to contact pin receivers 15 that are an integral part of insert 42. Boot seals 38 assemble over conductors 12 and insert insulation posts 39 to provide an electrically insulating barrier between the insulating fluid media cavity 40 and each individual electrical circuit. This is a secondary seal in the event of primary seal failure when conductive media ingresses into the insulating fluid media filled cavity.

The insert 42 is sealed to the connector main body 43 by o-rings 41 preventing fluid media from the fluid filled media cavity 40 coming onto contact with elastomer moulded connector terminal block 11. Rotatable threaded ring 44 is fitted over main body 43 and backshell 37 is fitted in place over o-rings 35 and 45 and secured with screws 34. Removal of fill port screw assembly 47 enables insulating fluid media cavity 40 to be filled with insulating fluid media. Replacement of fill port screw assembly reseals the cavity from the ambient environment.

This dry or wet mateable cable plug connector may be interengaged with any receptacle connector with the same number of pin contacts.

It will of course be understood that the invention is not limited to the specific details described herein, which are given by way of example only, and that various modifications and alterations are possible within the scope of the appended claims.

1.-24. (canceled)

25. (newly presented) A cable termination having a housing adapted to receive a cable at one end and present a contact terminal block at the other, the termination comprising:
a terminal block having one or more terminal contacts each having a contact interface to which the or each exposed conductor of a connecting cable is operably secured;
the terminal block including a face plate to retain the terminal block within a body of the cable termination; and
support means having a through-body passage for receiving each sheathed conductor after unbundling from a connecting cable,
in which the support means provides controlled conductor management by guiding and supporting each conductor after unbundling and presenting the conductor in alignment with its corresponding contact interface in the terminal block and is adapted to abut the face plate to provide enhanced structural integrity to the conductors and contact interfaces,
and in which each through-body passage is shaped in such a way so that the in use position of each conductor in relation to the central axis of the support means as presented to the face plate of the terminal block is different.

26. A cable termination as claimed in claim 25, in which the housing includes a cavity adapted to receive isolating media and the guiding passages each including sealing surfaces so as to prevent fluid passing from one side of the support means when a pressure differential is present across the support means.

27. A cable termination as claimed in claim 25, in which the termination is a two-part connector comprising:
a first male part having a plurality of terminal contacts extending beyond the face plate;
a second female part having terminal receivers adapted to align and couple with respective ones of the contacts of the male part;
at least one of said parts having a transitional region within the housing thereof where individual conductors are unbundled from a connecting cable which has sheathing to protect the individual conductors from hazardous environments; and
the transitional region comprising the area between a cable gripping means and the contact interfaces of said at least one part,
wherein, as individual conductors are exposed from within the protective sheathing and unbundled from the cable core, the support means receives each individual conductor within corresponding through-body passages to present an exposed conductor end in alignment with its corresponding contact interface.

28. A cable termination as claimed in claim 25, in which the support means through-body passages define conductor paths therewithin and functionally provides a bore area adjustment means to modify the space provided between each conductor and to align the conductors with respective contact interfaces at a terminal block within the housing of a cable termination or one or both of male and female parts thereof.

29. A cable termination as claimed in claim 27, in which the first male part has a plurality of terminal contacts and the second female part has terminal receivers adapted to receive and electrically connect with respective ones of the terminal contacts, each part having a cavity containing fluid electrically insulating media and said female part having means to ensure conductivity between the contact interfaces of the respective parts to define an electrical connector.

30. A cable termination as claimed in claim 27, in which the first male part has a plurality of contact interfaces or ferrules aligned with exposed optical fibres or waveguides presenting at terminal contacts and the second female part has terminal receivers adapted to align and couple with respective ones of the terminal contacts and are optically coupled to corresponding fibre interfaces/ferrules, a chamber containing optically isolating media and said female part having biasing means to ensure alignment and interfacing of the prepared terminal contacts and said receivers to define an optical connector.

31. A cable termination as claimed in claim 25, in which the support means comprises a monolithic block of an electrically insulating pressure resistant plastics material and selected ones of the passages defined therein deflect from the central axis to effect a bore adjustment means.

32. A cable termination as claimed in claim 25, in which the support means is formed using a three-dimensional or additive manufacturing technique so as to define convoluted conductor passages therein.

33. A cable termination as claimed in claim 31, in which the support means comprises two identical monolithic blocks, one disposed in the opposite orientation to the other, so that the deflection of the conductors through said bore area adjustment means provides a locking effect when the blocks abut one another, thereby providing further integrity to the support of the conductors and preventing strain being translated from the cable through the conductors to the terminal block.

34. cable termination as claimed in claim 25, in which the support means is provided as retrofittable into existing connectors as it does not interfere with the sealing, against the hazardous environment, of the cable termination or of the first or second part of a two-part connector and said terminal contacts or receivers thereof.

35. A cable termination as claimed in claim 25, in which the or each connector housing includes an annular retention means bevelled on one side to slidingly receive a radially deflecting ring of a threaded sleeve or collar and a locking profile on the other side thereof to retain the ring when axial tension is applied and in which the ring of the threaded sleeve or collar is slotted to provide regions adapted to radially flare during fitting to a connector housing and subsequently engage the locking profile of said retention means.

36. (newly presented) A cable termination as claimed in claim 35, in which a collar on a first connector part has an external thread and the sleeve on the mating connector part has a corresponding internal thread which are inter-engaged after mating of the connector parts and lock against the locking profiles of the respective retention means.

37. A cable termination as claimed in claim 25, in which the cable termination connector housing is adapted to sealingly receive a connector insert which cooperates with the connector housing moulding to form an elastomeric terminal block.

38. A conductor management device comprising a support means of claim 25 configured as a conductor locking means comprising:
a support means defining first monolithic block having a plurality of conductor routing passages to define respective bore modifying paths within the block; and
a support means defining second block having the same characteristic features as the first but in which the direction of bore modification is opposed,
wherein, in use, the first block is mounted on the presented conductors and positioned at or adjacent a desired locking position before the second block is mounted on said conductors and slid towards the first, so that when the locking position is accurately determined, the first and second blocks are brought into locking engagement.

39. A conductor management device as claimed in claim 38, in which a sleeve or encapsulating body holds the blocks together effectively to retain the blocks in locking engagement, the two blocks being held within a connector part and subsequently encapsulated by insulating media.

40. A conductor management device as claimed in claim 38, in which the blocks are configured as conductor sealing means whereby the desired locking position comprises an optimum sealing position so that when the blocks abut, they form a sealing engagement.

41. A method of locking conductors within a cable termination or connector part thereof utilising a support means of claim 25, the method including:
unbundling connectors from a multi-conductor cable;
sliding a support means, having a plurality of conductor routing passages defining bore modifying paths within the support means, along the unbundled conductors towards the cable;
exposing the conductor tips by stripping the sheathing therefrom;
fixing the conductors to their respective contact interfaces; and
sliding the device into abutment with the terminal block.

42. A method of locking conductors within a connector part as claimed in claim 41, the method further including sliding a first support means having bore modifying passages onto the conductors to concentrate them radially before sliding a second support means in opposite bore modifying orientation onto the conductors to align the conductors with respective terminal block contact interfaces and in which a second support means is slid into abutment with the terminal block, the first support means being subsequently slid into locking engagement with the second to prevent strain forces being translated through the conductors to the terminal block.

43. An electrical connector as claimed in claim 25, in which the cable termination or either one or both of the male and female connector parts includes a support means defining a conductor management device in accordance with claim 38.

44. An optical cable termination or two-part connector as claimed in claim 25, in which individual optical fibres are interfaced to ensure passage of data, wherein support means defining a conductor management device in accordance with claim 38 is provided.
